(19) United States
(12) Patent Application Publication
(10) Pub. No.: US 2025/0077946 A1
(43) Pub. Date: Mar. 6, 2025

(54) SYSTEMS AND METHODS FOR GENERATING CONTEXTUAL DATA FOR TRAINING DOWNSTREAM MODELS

(71) Applicant: Capital One Services, LLC, McLean, VA (US)

(72) Inventors: Samuel SHARPE, Cambridge, MA (US); Christopher Bayan BRUSS, Washington, DC (US); Brian BARR, Schenectady, NY (US)

(73) Assignee: Capital One Services, LLC, McLean, VA (US)

(21) Appl. No.: 18/457,186

(22) Filed: Aug. 28, 2023

(51) Int. Cl. G06N 20/00; G06F 9/451

(52) U.S. Cl. CPC G06N 20/00; G06F 9/451

(57) ABSTRACT

Systems and methods for ranking user interface elements using explainability vectors. The system receives training data for a ranking machine learning model. The training data comprises values for a first set of features. The system trains the ranking machine learning model using the training data. The system processes the ranking model to extract an explainability vector. Based on the explainability vector, the system processes the first set of features to generate a second set of features. The system processes the second set of features and the output of the predictive machine learning model to generate an explanative factor and trains a ranking model using the explanative factor and a third set of features. The system receives as output from the ranking model a vector indicating display positions and rankings of user interface elements.

### SUMMARY

Machine learning models for complex tasks often utilize pre-processing methods, including pretrained upstream models that produce training data for use in downstream models. For example, a natural language processing framework that performs sentiment analysis might use an upstream model to perform preprocessing on raw text data, including word standardization and tokenization to generate numerical representations of text. A downstream model may then be trained to classify such numerical representations into categories of sentiment.

Methods and systems are described herein for novel uses and/or improvements to artificial intelligence applications. Providing the output of the upstream model to the downstream model may not adequately transfer the insights of the upstream model. For example, classification edge cases (e.g., data which appears to belong in more than one category) in the downstream model may benefit from receiving more context from the upstream model. For example, in addition to providing the output of the upstream model, an explanation or approximation of factors used by the upstream model to determine the output may offer useful context for training the downstream model.

Conventional systems have not contemplated leveraging an explainability vector for feature selection and/or recombination of a set of features for a downstream machine learning model. For example, an explainability vector for an upstream machine learning model for predicting resource availability may shed light on which input factors correlate more, or less, with predicted resource availability. The explainability vector for the upstream model may be used to guide assessments on the importance of features, which give context to the downstream model when it uses the upstream model's predictions. This provides the practical benefit of informative features for the second machine learning model which improves prediction accuracy for the second machine learning model with respect to the first machine learning model.

The difficulty in adapting artificial intelligence models for this practical benefit faces several technical challenges such as how to process the explainability vector in preparation for feature extraction, how to set metrics for feature selection, and how to translate the first set of features into the second set. To overcome these technical deficiencies in adapting artificial intelligence models for this practical benefit, methods and systems disclosed herein extract explainability vectors from machine learning models which speaks to the importance of parameters to a first model. The explainability vectors are then used to perform principal component analysis or factor analysis which suggest prominent features for future use. The features may be selected for maximal explanative power and/or some other criterion. The system may generate an encoding map to translate values for the first set of features into the second set. Thus, methods and systems disclosed herein make use of explainability vectors from upstream models to provide context alongside data to downstream models which improves model accuracy and transparency.

For example, features used by a predictive upstream model in generating its outputs (e.g., resource availability scores) may be converted or recombined into an explanative factor. The recombined features may be indicative of, for example, a task type causing especially heavy resource consumption and affecting availability in some instances. A downstream model that uses the output of the predictive upstream model may use the explanative factor instead of or in addition to the output of the upstream model. For example, a workload scheduling model dynamically responsive to resource availabilities can incorporate the task type that caused heavy resource consumption and plan accordingly based on the explanative factor. In some aspects, methods and systems are described herein for generating a downstream machine learning model from an upstream model trained to determine resource availability by a user system. The downstream model uses the output of the upstream model as an input, and the relative importance and influence of features in generating the output of the upstream model may also be instructive for the downstream model. Therefore, methods and systems described herein provide as input to the downstream model an alternate set of features (e.g., subset or combination of features or a variation thereof) determined using an explainability vector from the set of features for the machine learning model. The explainability vector may be extracted from the machine learning model wherein each entry in the explainability vector may correspond to a feature and be indicative of a correlation between the feature and the output of the first machine learning model.

For example, a model may be trained to rank and order elements for a user interface displaying factors related to assignments of resource availability. The ranking model may benefit from customizing the order of factors on the user interface based on the circumstances of the user system subject to the assignment of resource availability. For example, the ranking model, when generating an output indicating user interface order and display positions for a user system denied an amount of resources, may benefit from consideration of the factors that caused the user system to be denied (e.g., inefficiency in running a type of task related to the resource in question). Therefore, the ranking model may improve the accuracy of its outputs via taking as input an explanative factor including the features in a model for generating resource availability scores. The explanative factor may illustrate the nature and extent of the impact on the output of the predictive model from a feature.

In some aspects, methods and systems are described herein for generating a downstream machine learning model from an upstream model trained to determine resource availability by a user system. The downstream model ranks user interface elements using the output of the upstream model as an input, and the relative importance and influence of features in generating the output of the upstream model may also be instructive for the downstream model. Therefore, methods and systems described herein provide as input to the downstream model an alternate set of features (e.g., subset or combination of features or a variation thereof) determined using an explainability vector from the set of features for the machine learning model. The explainability vector may be extracted from the machine learning model wherein each entry in the explainability vector may correspond to a feature and be indicative of a correlation between the feature and the output of the first machine learning model.

In some aspects, methods and systems are described herein comprising: receiving training data for an upstream machine learning model, wherein the training data comprises values for a first set of features; training the upstream machine learning model using the training data; in response to training the upstream machine learning model, processing the upstream machine learning model to extract an explainability vector, wherein each entry in the explainability vector corresponds to a feature in the first set of features and is indicative of a correlation between the feature and output of the upstream machine learning model; based on the explainability vector, processing the first set of features to generate a second set of features; processing the second set of features and the output of the upstream machine learning model to generate an explanative factor, wherein the explanative factor includes a set of features specifying real values which correspond to correlations between the second set of features and outputs of the upstream machine learning model; and training a downstream machine learning model, wherein the downstream machine learning model uses a third set of features and the explanative factor as input.

In some aspects, methods and systems are described herein comprising: receiving training data for a predictive machine learning model that outputs resource availability scores, wherein the training data comprises values for a first set of features; training the predictive machine learning model using the training data; in response to training the predictive machine learning model, processing the predictive machine learning model to extract an explainability vector, wherein each entry in the explainability vector corresponds to a feature in the first set of features and is indicative of a correlation between the feature and an output of the predictive machine learning model; based on the explainability vector, processing the first set of features to generate a second set of features; processing the second set of features and the output of the predictive machine learning model to generate an explanative factor; training a ranking machine learning model, wherein the ranking machine learning model takes a third set of features and the explanative factor as input; and receiving, as output from the ranking machine learning model, a vector indicating display positions and rankings of one or more user interface elements.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for generating contextual data for downstream models using explainability vectors, in accordance with one or more embodiments.

FIG. 2 show an illustration of a first set of features being translated into a second set of features, in accordance with one or more embodiments.

FIG. 3 shows illustrative components for a system for generating contextual data for downstream models using explainability vectors, in accordance with one or more embodiments.

FIG. 4 shows a flowchart of the steps involved in generating contextual data for downstream models using explainability vectors, in accordance with one or more embodiments.

FIG. 5 shows a flowchart of the steps involved in ranking user interface elements using explainability vectors, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

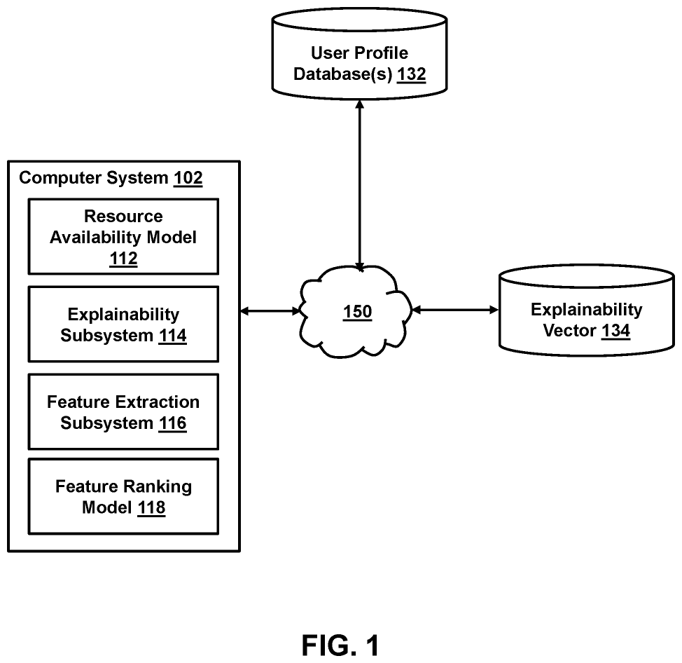

FIG. 1 shows an illustrative diagram for system 150, which contains hardware and software components used to train resource availability machine learning models, extract explainability vectors and perform feature engineering, in accordance with one or more embodiments. For example, Computer System 102, a part of system 150, may include Resource Availability Model 112, Explainability Subsystem 114, Feature Extraction Subsystem 116, and Feature Ranking Model 118.

System 150 (the system) may retrieve a plurality of user profiles from User Profile Database(s) 132. Each user profile in User Profile Database(s) 132 corresponds to a user system, and contains information described by a first set of features. The first set of features may contain categorical or quantitative variables, and values for such features may describe, for example, the user system's make and model, the user system's location, the membership of the user system in any networks, any allocations of resources to the user system, a length of time for which the user system has recorded resource consumption, an extent and frequency of resource consumption, and the number of instances of the user system's excessive resource consumption. Each user profile may correspond to a resource availability value indicating the current amount of resources that should be made available to or reserved for the user system, which may also be recorded in User Profile Database(s) 132 in association with the user profile. The system may retrieve a plurality of user profiles as a matrix including vectors of feature values for the first set of features and append to the end of each vector a resource consumption value.

In some embodiments, the system may, before retrieving user profiles, process User Profile Database(s) 132 using a data cleansing process to generate a processed dataset. The data cleansing process may include removing outliers, standardizing data types, formatting and units of measurement, and removing duplicate data. The system may then retrieve vectors corresponding to user profiles from the processed dataset.

The system may train a first machine learning model (e.g., Resource Availability Model 112) based on a matrix representing the plurality of user profiles. This model may also be referred to as an “upstream machine learning model”. Resource Availability Model 112 may take as input a vector of feature values for the first set of features and output a resource consumption score indicating an amount of resources used by a user system with such feature values as the input. Resource Availability Model 112 may use one or more algorithms like linear regression, generalized additive models, artificial neural networks or random forests to achieve quantitative prediction. The system may partition the matrix of user profiles into a training set and a cross-validating set. Using the training set, the system may train Resource Availability Model 112 using, for example, the gradient descent technique. The system may then cross-validate the trained model using the cross-validating set and further fine-tune the parameters of the model. Resource Availability Model 112 may include one or more parameters that it uses to translate input into outputs. For example, an artificial neural network contains a matrix of weights, each weight in which is a real number. The repeated multiplication and combination of weights transform input values to Resource Availability Model 112 into output values.

In some embodiments, Resource Availability Model 112 may be a preprocessor model whose output is used as input by a downstream model (e.g., Feature Ranking Model 118). For example, Resource Availability Model 112 may be a bidirectional encoder representation transformer model. The model may take text sequences as input, which uses a transformer embedding to generate representations of text tokens such as words or sentences.

The system may use Explainability Subsystem 114 to extract an explainability vector (e.g., Explainability Vector 134) from Resource Availability Model 112. Explainability Subsystem 114 may employ a variety of explainability techniques depending on the algorithms in Resource Availability Model 112 to extract Explainability Vector 134. Explainability Vector 134 contains one entry for each feature in the set of features in the input to Resource Availability Model 112, and the entry reflects the importance of that feature to the model. The values within Explainability Vector 134 additionally represent how each features correlates to the output of the model, and the causative effect of each feature in producing the output as construed by the model. In some embodiments, a correlation matrix may be attached to Explainability Vector 134. The correlation matrix captures how variables are correlated with other variables. This is relevant because correlation between variables in a model causes interference in their causative effects in producing the output of the model.

Below are some examples of how Explainability Subsystem 114 extracts Explainability Vector 134 from Resource Availability Model 112.

For example, Resource Availability Model 112 may contain a matrix of weights for a multivariate regression algorithm. Explainability Subsystem 114 may use a Shapley Additive Explanation method to extract Explainability Vector 134. Shapley Additive Explanation computes Shapley values in coalitional game theory, treating each feature in the input features of a model as participants in a coalition. Each feature therefore gets assigned a Shapley value capturing their contribution to producing the prediction of the model. The magnitude of Shapley values of each feature is then normalized. Explainability Vector 134 may be a list of normalized Shapley values of each feature.

In another example, Resource Availability Model 112 may contain a vector of coefficients for a generalized additive model. Since the nature of generalized additive models is such that the effect of each variable on the output is completely and independently captured by its coefficient, Explainability Subsystem 114 may take the list of coefficients to be Explainability Vector 134.

In another example, Resource Availability Model 112 may contain a matrix of weights for a supervised classifier algorithm. Explainability Subsystem 114 may use a Local Interpretable Model-agnostic Explanations method to extract Explainability Vector 134. The Local Interpretable Model-agnostic Explanations approximates the results of Resource Availability Model 112 with an explainable model, e.g., a decision tree classifier. The approximate model is trained using a loss heuristic that judges similarity to Resource Availability Model 112 and that penalizes complexity. In some embodiments, the number of variables that the approximate model uses can be specified. The approximate model will clearly define the effect of each feature on the output: for example, the approximate model may be a generalized additive model.

In another example, Resource Availability Model 112 may contain a matrix of weights for a convolutional neural network algorithm. Explainability Subsystem 114 may use a Gradient Class Activation Mapping method to extract Explainability Vector 134. The Grad-CAM technique performs backpropagation on the output of the model with respect to the final convolutional feature map to compute derivatives of features in the input with respect to the output of the model. The derivatives may then be used as indications of importance of features to a model, and Explainability Vector 134 may be a list of such derivatives.

In another example, Resource Availability Model 112 may contain a set of parameters comprising a hyperplane matrix for a support vector machine algorithm. Explainability Subsystem 114 may use a counterfactual explanation method to extract Explainability Vector 134. The counterfactual explanation method looks for input data which are identical or extremely close in values for all features except one. Then the difference in prediction results may divided by the difference in the divergent value. This process is repeated on each feature for all pairs of available input vectors, and the aggregated result is a measure for the effect of each feature on the output of the model, which may be formed into Explainability Vector 134.

After extracting Explainability Vector 134 from Resource Availability Model 112, the system (e.g., using Feature Extraction Subsystem 116) may process the explainability vector using one or more filtering criteria to adjust the values corresponding to certain features. In some embodiments, these adjustments may be performed in response to a user request. For example, the system may receive a user request specifying that a subset of features be removed from consideration or that impact of the subset of features be reduced. In one example embodiment, the system may receive user profiles representing applicants for credit cards. A feature in the set of features may be the race or ethnicity of the applicant. The user may wish to exclude such features from consideration. Therefore, a subset of features to be removed may include, e.g., race and gender. Feature Extraction Subsystem 116 may, in addition, calculate a threshold for removing features of the explainability vector. In some embodiments, the threshold may correspond to a pre-set real number, e.g., 0.45. In other embodiments, Feature Extraction Subsystem 116 may simply remove the bottom 10% of features ranked by values in the explainability vector. Using the threshold, Feature Extraction Subsystem 116 may add features to the subset of features to be removed. Feature Extraction Subsystem 116 may apply a mathematical transformation to the explainability vector such that values corresponding to the subset of features are adjusted. For example, the values in the explainability vector for the subset of features may be set to zero, or the values may be halved.

The system may use Explainability Vector 134 to generate a second set of features (e.g., using Feature Extraction Subsystem 116). In addition to the removal and transformation of features described above, Feature Extraction Subsystem 116 may combine features with reference to Explainability Vector 134. For example, it may select features with low values in Explainability Vector 134 and map one or more such features into one combined feature. Feature Extraction Subsystem 116 may, for example, multiply the absolute values for three features to generate one new feature. Alternatively, Feature Extraction Subsystem 116 may determine whether all three feature values exceed thresholds for each and create a new feature which outputs 1 if all values are above their respect thresholds, and outputs 0 otherwise. In some embodiments, Feature Extraction Subsystem 116 may use the correlation matrix attached with Explainability Vector 134 to determine which features to combine. In some embodiments, the system may use a deep neural network to learn weights and combination rules for Feature Extraction Subsystem 116 using Explainability Vector 134 as an input.

In some embodiments, Feature Extraction Subsystem 116 may employ a variety of techniques to rearrange or recombine the first set of features into the second set of features. For example, Feature Extraction Subsystem 116 may normalize Explainability Vector 134 into a standard-deviation space to produce a processed vector. Then, with reference to the correlation matrix attached to Explainability Vector 134, Feature Extraction Subsystem 116 may generate a covariance matrix based on the processed vector. The covariance matrix captures how the effects on the output of the model of one or more features correlate. Using the covariance matrix, Feature Extraction Subsystem 116 may compute a set of eigenvectors and eigenvalues for the covariance matrix (e.g., through the Singular Value Decomposition method). Each eigenvector corresponds to an eigenvalue and represents a feature in the first set of features. The relative proportions of the eigenvalues are directly correlated with the magnitude of a factor's explanative weight in Resource Availability Model 112. By normalizing the eigenvalues of all features in the first set of features, the system may determine what percentage of the explanative power of the model may be captured by each feature. Feature Extraction Subsystem 116 may then select a measure of coverage (e.g., a threshold percentage of the explanative power of the model). Using the measure of coverage, Feature Extraction Subsystem 116 may select a subset of eigenvectors from the set of eigenvectors. For example, if the measure of coverage is 55%, and three eigenvectors' eigenvalues add up to 56% when normalized, Feature Extraction Subsystem 116 may select the three eigenvectors. Feature Extraction Subsystem 116 may then determine the second set of features to correspond to the subset of eigenvectors.

In some embodiments, after Feature Extraction Subsystem 116 has processed the covariance matrix (also referred to herein as a correlation matrix) to generate a set of eigenvectors, Feature Extraction Subsystem 116 may compute a distribution of eigenvalues corresponding to the set of eigenvectors. Using the distribution of eigenvalues, the system may set a threshold and use a maximum-likelihood estimator model to extract the second set of features.

Having selected a second set of features, the system may generate an encoding map to translate values for the first set of features into the second set of features. The encoding map may be a series of rules and transformations that take a vector of input data (e.g., values for features in the first set of features), applies mathematical transformations like weight multiplications and Boolean combinations to the vector of input data, and produces an output vector which represents feature values for the second set of features. For example, an input vector of the values [23, 0.7, 100, 66, 80.4] may be taken into an encoding map. The encoding map may multiply the first feature by 1.774 to obtain the first output value. The encoding map may determine whether the second feature is greater than 0.5: if it is, the second output value is set to 1 and if not, it is set to 0. The encoding map may calculate a difference between the third and fourth features (e.g., 34) to be the third output value. The encoding map may ignore the fifth feature. Thus, the encoding map in this example takes an input vector of [23, 0.7, 100, 66, 80.4] and outputs a vector of values [40.802, 1, 34]. In another example, an encoding map may translate categorical variables. For example, the feature of “industry group” with the value of “real estate” may be represented as 503 in the output. The encoding map may store weights, rules, and other information in hardware and/or software.

In some embodiments, the system may use the encoding map to encode a plurality of user profiles, where each profile contains values for the first set of features. The user profiles may describe features that correlate with resource availability. For example, each user profile may represent an application for a line of credit. The system may train a predictive machine learning model (e.g., Resource Availability Model 112) using the plurality of user profiles. Resource Availability Model 112 may predict a first set of outputs symbolizing resource availability values for user profiles. The system may use an explainability vector extracted from Resource Availability Model 112 to generate a second set of features. The system may combine the second set of features and the first set of outputs (e.g., generated from the first set of features corresponding to the plurality of user profiles) to generate an explanative factor. For example, the explanative factor may be a matrix of real values, each row of which contains a set of values for the second set of features and a value for an output from Resource Availability Model 112. The explanative factor may capture the considerations of Resource Availability Model 112 in generating outputs.

In some embodiments, the downstream model (e.g., Feature Ranking Model 118) may rank and order the first set of features used by the upstream model (e.g., Resource Availability Model 112) and may cause user interface elements corresponding to one or more features in the first set of features to displayed in a particular order or arrangement. To do so, Feature Ranking Model 118 may use a third set of features, which may be independent and different from the first set and the second set of features, to predict the display orders and positions of user interface elements on a user interface, which may correspond to expected perceptions of importance by the user and/or the probabilities that one or more of resources corresponding to the user interface elements will be accessed by the user. The third set of features may include, for example, the historical click-through rates for one or more user interface elements, among other features. The third set of features is not informed by the output of the upstream model (e.g., Resource Availability Model 112) and therefore do not overlap with the first or second sets of features. For example, a model may be trained to rank and order features solely using the third set of features. However, the system may instead train Feature Ranking Model 118 using the third set of features as well as the explanative factor like generated above. For example, Feature Ranking Model 118 may take input vectors in the same format as the explanative factor, which includes the second set of features and the output of Resource Availability Model 112.

In training Feature Ranking Model 118, the system may partition the explanative factor into a training set and a cross-validating set. Using the training set, the system may train Feature Ranking Model 118 using, for example, the gradient descent technique. The system may then cross-validate the trained model using the cross-validating set and further fine-tune the parameters of the model. In some embodiments, Feature Ranking Model 118 may be trained to output vectors representative of rankings of user interface elements, which the system can use to determine display positions and rankings of user interface elements.

In another example, an upstream machine learning model (e.g., Resource Availability Model 112) may be trained on a corpus of raw text data to be a bidirectional encoder representation transformer model. The upstream model may take a first set of features an input and output a set of text representation tokens, each of which is a vector of real values corresponding to a word or a collection of words. The text representation tokens may be used as pre-processing for a downstream natural language processing model. The system may generate an explainability vector using the upstream model and use the explainability vector to process the first set of features into a second set of features. The system may then use the second set of features and the set of text representation tokens to generate an explanative factor. The system may train the downstream model using the explanative factor and a third set of features. The third set of features may relate only to the task of the downstream model. For example, the downstream model corresponding to a bidirectional encoder representation transformer upstream model may be a text sentiment analysis model. In addition to the explanative factor, the downstream model may use input text data and metadata associated with the text such as its source and its traffic data as training inputs. The downstream model may be trained to output sentiment classifications for the input text data contained in the third set of features.

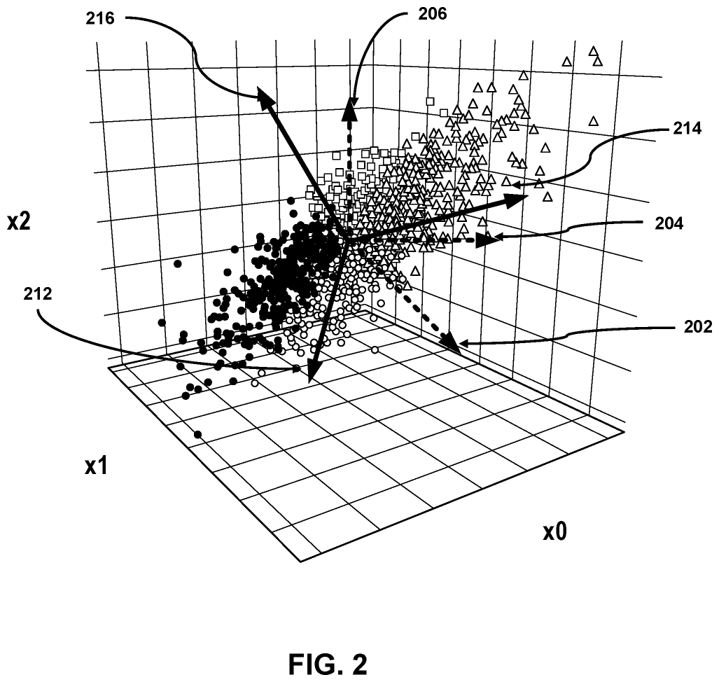

FIG. 2 is a demonstration of a first set of features and a second set of features. The first set of features may, in this example, contain three axes represented by three unit vectors: 202, 204 and 206. They are also labeled x0, x1 and x2 on FIG. 2. A user profile described by the first set of features may be represented as a vector of three real values, corresponding respectively to unit vector 202, unit vector 204 and unit vector 206. In some embodiments, user profiles thus described may be classified or clustered in this space by Resource Availability Model 112.

Using, for example, the methods described above, this first set of features may give rise to a second set of features. The second set of features, in this example, is also three-dimensional. Unit vector 212, unit vector 214 and unit vector 216 represent the axes defining the three features. A user profiles with the second set of features is described by real values along these three dimensions. The second set of features may be the result of a recombination of unit vector 202, unit vector 204 and unit vector 206. The same user profile may be described by a set of real values for the first set of features and a different set of real values for the second set of features. An encoding map may be used to translate values for the first set of features into the second set of features. For example, an encoding map may take a user profile vector for the first set of features [2.3, 4, 9], corresponding to unit vector 202, 204 and 206. The encoding map may contain a list of weights [2, 10, 12] which may be applied to onto the user profile vector to produce a vector with values [4.6, 40, 108]. This vector encapsulates the user profile in the second set of features. Feature Ranking Model 118 may then process this vector corresponding to the user profile to produce, for example, resource consumption values.

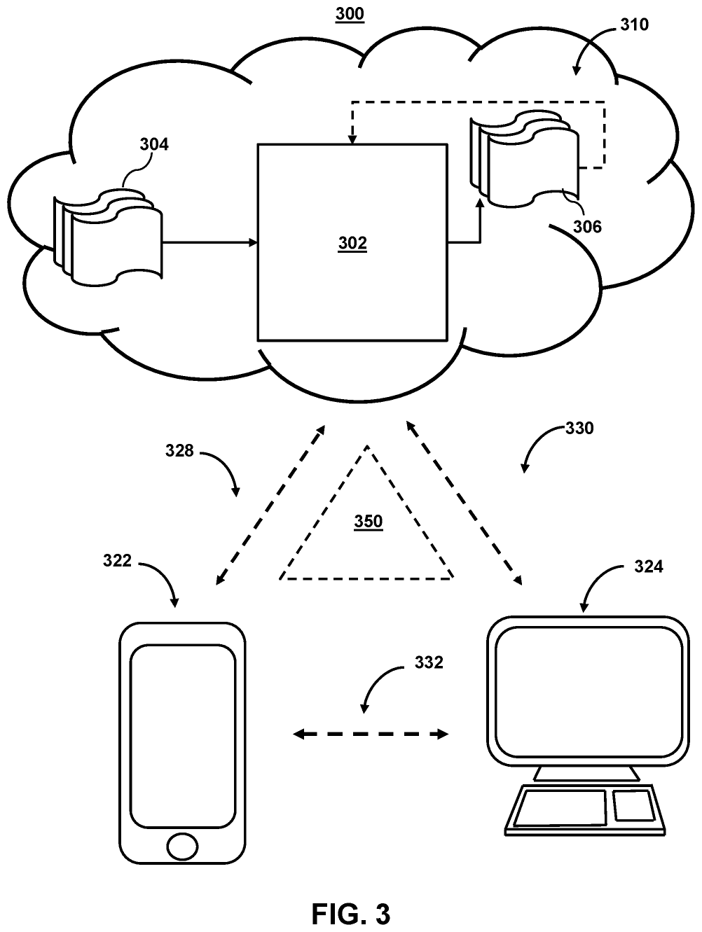

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., predicting resource allocation values for user systems).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., predicting resource allocation values for user systems).

In some embodiments, the model (e.g., model 302) may automatically perform actions based on outputs 306. In some embodiments, the model (e.g., model 302) may not perform any actions. The output of the model (e.g., model 302) may be used to predict predicting resource allocation values for user systems).

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDoS protection, and API layer 350 may use RESTful APIs as standard for external integration.

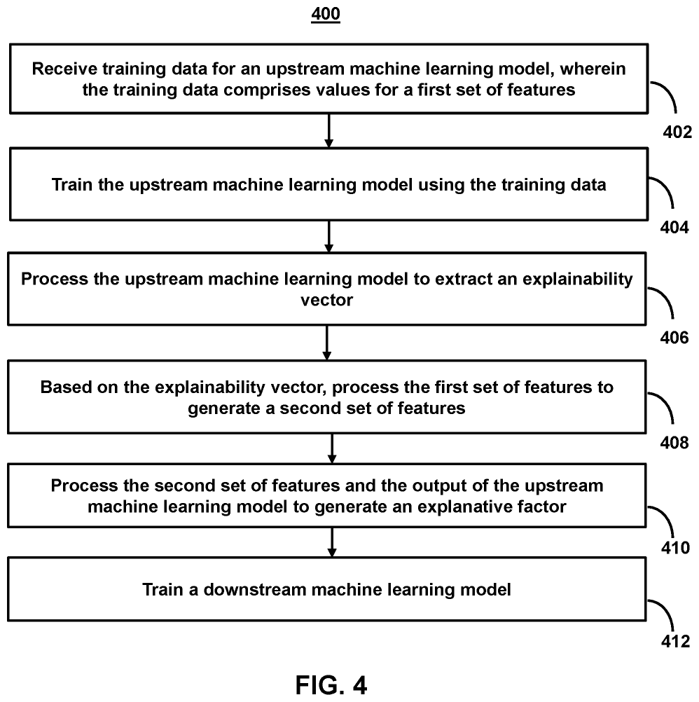

FIG. 4 shows a flowchart of the steps involved in generating contextual data for downstream models using explainability vectors, in accordance with one or more embodiments. For example, the system may use process 400 (e.g., as implemented on one or more system components described above) in order to collect and process data about users, train resource consumption models, extract explainability vectors, and select and recombine features.

At step 402, process 400 (e.g., using one or more components described above) receives training data for an upstream machine learning model, wherein the training data comprises values for a first set of features. To do so, the system may retrieve one or more user profiles from User Profile Database(s) 132 and combine corresponding resource consumption values with the user profiles to generate a dataset. The system may retrieve, for a first plurality of user systems, a first plurality of user profiles, wherein each user profile includes values for a first set of features. For example, the system may use one or more software components (e.g., application programming interfaces) to browse User Profile Database(s) 132 and retrieve a dataset each entry for which corresponds to a user. A user profile is described by values in the first set of features. The first set of features may include quantitative or categorical variables. For example, the first set of features may include length of credit history, revolving credit utilization, credit lines and types of credit for a dataset relating to the creditworthiness of individuals. In some embodiments, the system may process the dataset of user profiles or User Profile Database(s) 132 using a data cleansing process to generate a processed dataset. The data cleansing process may include removing outliers, standardizing data types, formatting and units of measurement, and removing duplicate data. By collecting high-quality user profile data, the system may fully inform models that determine resource consumption for user systems.

At step 404, process 400 (e.g., using one or more components described above) trains the upstream machine learning model using the training data. The dataset may then be divided into a training set and a cross-validating set. The system may train the first machine learning model (e.g., Resource Availability Model 112) using the training set and tune parameters using the cross-validating set. The first machine learning model receives as input values for the set of features within User Profile Database(s) 132 and generates as output a corresponding resource consumption value. The upstream model may be, for example, a model which generates resource availability scores. The upstream model may, for example, take user profile data as input and generate as output vectors corresponding amounts of resources of different types allocated to input user profiles.

At step 406, process 400 (e.g., using one or more components described above) processes the upstream machine learning model to extract an explainability vector. For example, if the first machine learning model is defined by a set of parameters comprising a matrix of weights for a multivariate regression algorithm, the explainability vector may be extracted from the set of parameters using the Shapley Additive Explanation method. For example, if the first machine learning model is defined by a set of parameters comprising a matrix of weights for a supervised classifier algorithm, the explainability vector may be extracted from the set of parameters using the Local Interpretable Model-agnostic Explanations method. For example, if the first machine learning model is defined by a set of parameters comprising a vector of coefficients for a generalized additive model, the explainability vector may be extracted from the vector of coefficients in the generalized additive model. For example, if the first machine learning model is defined by a set of parameters comprising a matrix of weights for a convolutional neural network algorithm, the explainability vector may be extracted from the set of parameters using the Gradient Class Activation Mapping method. For example, if the first machine learning model is defined by a set of parameters comprising a hyperplane matrix for a support vector machine algorithm, the explainability vector may be extracted from the set of parameters using the counterfactual explanation method. The explainability vector thus extracted (e.g., Explainability Vector 134) has the same number of entries as features in the first set of features. Each entry in this explainability vector represents the impact that a particular feature has on the model output.

At step 408, process 400 (e.g., using one or more components described above) processes the first set of features to generate a second set of features based on the explainability vector. In some embodiments, the system may first adjust values in the explainability vector. For example, the system may receive a user request specifying that a subset of features be removed from consideration or that impact of the subset of features be reduced. The system may also calculate a threshold for removing features of the explainability vector and add features below the threshold to the subset of features. This threshold may remove features deemed unimportant and may be a particular value in the explainability vector (e.g., 0.25). In some embodiments, this threshold can be a predetermined set number; in some other embodiments the threshold may be selected from the explainability vector. The system may apply a mathematical transformation to the explainability vector such that values corresponding to the subset of features are adjusted. In some embodiments, the values may be set to 0 to remove the corresponding features from consideration. In some embodiments, a percentage may be subtracted the values to downplay their impact.

The system (e.g., Feature Extraction Subsystem 116) may process the explainability vector to rearrange the first set of features into a second set of features. For example, Feature Extraction Subsystem 116 may process the explainability vector using one or more filtering criteria to adjust the values corresponding to certain features. For example, the system may receive a user request specifying that a subset of features be removed from consideration or that impact of the subset of features be reduced. In one example embodiment, the system may receive user profiles representing applicants for credit cards. A feature in the set of features may be the race or ethnicity of the applicant. The user may wish to exclude such features from consideration. Therefore, a subset of features to be removed may include, e.g., race and gender. Feature Extraction Subsystem 116 may, in addition, calculate a threshold for removing features of the explainability vector. In some embodiments, the threshold may correspond to a pre-set real number, e.g., 0.45. In other embodiments, Feature Extraction Subsystem 116 may simply remove the bottom 10% of features ranked by values in the explainability vector. Using the threshold, Feature Extraction Subsystem 116 may add features to the subset of features to be removed. Feature Extraction Subsystem 116 may apply a mathematical transformation to the explainability vector such that values corresponding to the subset of features are adjusted. For example, the values in the explainability vector for the subset of features may be set to zero, or the values may be halved.

In addition to the removal and transformation of features described above, Feature Extraction Subsystem 116 may combine features with reference to Explainability Vector 134. For example, it may select features with low values in Explainability Vector 134 and map one or more such features into one combined feature. Feature Extraction Subsystem 116 may, for example, multiply the absolute values for three features to generate one new feature. Alternatively, Feature Extraction Subsystem 116 may determine whether all three feature values exceed thresholds for each and create a new feature which outputs 1 if all values are above their respect thresholds, and outputs 0 otherwise. In some embodiments, Feature Extraction Subsystem 116 may use the correlation matrix attached with Explainability Vector 134 to determine which features to combine. In some embodiments, the system may use a deep neural network to learn weights and combination rules for Feature Extraction Subsystem 116 using Explainability Vector 134 as an input.

In some embodiments, Feature Extraction Subsystem 116 may employ a variety of techniques to rearrange or recombine the first set of features into the second set of features. For example, Feature Extraction Subsystem 116 may normalize Explainability Vector 134 into a standard-deviation space to produce a processed vector. Then, with reference to the correlation matrix attached to Explainability Vector 134, Feature Extraction Subsystem 116 may generate a covariance matrix based on the processed vector. The covariance matrix captures how the effects on the output of the model of one or more features correlate. Using the covariance matrix, Feature Extraction Subsystem 116 may compute a set of eigenvectors and eigenvalues for the covariance matrix (e.g., through the Singular Value Decomposition method). Each eigenvector corresponds to an eigenvalue and represents a feature in the first set of features. The relative proportions of the eigenvalues are directly correlated with the magnitude of a factor's explanative weight in Resource Availability Model 112. By normalizing the eigenvalues of all features in the first set of features, the system may determine what percentage of the explanative power of the model may be captured by each feature. Feature Extraction Subsystem 116 may then select a measure of coverage (e.g., a threshold percentage of the explanative power of the model). Using the measure of coverage, Feature Extraction Subsystem 116 may select a subset of eigenvectors from the set of eigenvectors. For example, if the measure of coverage is 55%, and three eigenvectors' eigenvalues add up to 56% when normalized, Feature Extraction Subsystem 116 may select the three eigenvectors. Feature Extraction Subsystem 116 may then determine the second set of features to correspond to the subset of eigenvectors.

At step 410, process 400 (e.g., using one or more components described above) processes the second set of features and the output of the upstream machine learning model to generate an explanative factor. For example, the explanative factor may be a matrix including values for the second set of features and for the first set of outputs. In training the downstream model, the system may partition the explanative factor into a training set and a cross-validating set. Using the training set, the system may train Feature Ranking Model 118 using, for example, the gradient descent technique. The system may then cross-validate the trained model using the cross-validating set and further fine-tune the parameters of the model. The explanative factor embodies the processes employed by Resource Availability Model 112 in generating its outputs that may be relevant to Feature Ranking Model 118. For example, features used by a predictive upstream model in generating its outputs (e.g., resource availability scores) may be converted or recombined into an explanative factor. The recombined features may be indicative of, for example, a task type causing especially heavy resource consumption and affecting availability in some instances. A downstream model that uses the output of the predictive upstream model may use the explanative factor instead of or in addition to the output of the upstream model. For example, a workload scheduling model dynamically responsive to resource availabilities can incorporate the task type that caused heavy resource consumption and plan accordingly based on the explanative factor.

At step 412, process 400 (e.g., using one or more components described above) trains a downstream machine learning model using the explanative factor and a third set of features as input. In some embodiments, the downstream model (e.g., Feature Ranking Model 118) may rank and order the first set of features used by the upstream model (e.g., Resource Availability Model 112) and may cause user interface elements corresponding to one or more features in the first set of features to displayed in a particular order or arrangement. To do so, Feature Ranking Model 118 may use a third set of features, which may be independent and different from the first set and the second set of features, to predict the display orders and positions of user interface elements on a user interface, which may correspond to expected perceptions of importance by the user and/or the probabilities that one or more of resources corresponding to the user interface elements will be accessed by the user. The third set of features may include, for example, the historical click-through rates for one or more user interface elements, among other features. The third set of features is not informed by the output of the upstream model (e.g., Resource Availability Model 112) and therefore do not overlap with the first or second sets of features. For example, a model may be trained to rank and order features solely using the third set of features. However, the system may instead train Feature Ranking Model 118 using the third set of features as well as the explanative factor like generated above. For example, Feature Ranking Model 118 may take input vectors in the same format as the explanative factor, which includes the second set of features and the output of Resource Availability Model 112. Feature Ranking Model 118 may output a vector symbolizing the rankings of user interface elements.

In another example, an upstream machine learning model (e.g., Resource Availability Model 112) may be trained on a corpus of raw text data to be a bidirectional encoder representation transformer model. The upstream model may take a first set of features an input and output a set of text representation tokens, each of which is a vector of real values corresponding to a word or a collection of words. The text representation tokens may be used as pre-processing for a downstream natural language processing model. The system may generate an explainability vector using the upstream model and use the explainability vector to process the first set of features into a second set of features. The system may then use the second set of features and the set of text representation tokens to generate an explanative factor. The system may train the downstream model using the explanative factor and a third set of features. The third set of features may relate only to the task of the downstream model. For example, the downstream model corresponding to a bidirectional encoder representation transformer upstream model may be a text sentiment analysis model. In addition to the explanative factor, the downstream model may use input text data and metadata associated with the text such as its source and its traffic data as training inputs. The downstream model may be trained to output sentiment classifications for the input text data contained in the third set of features.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

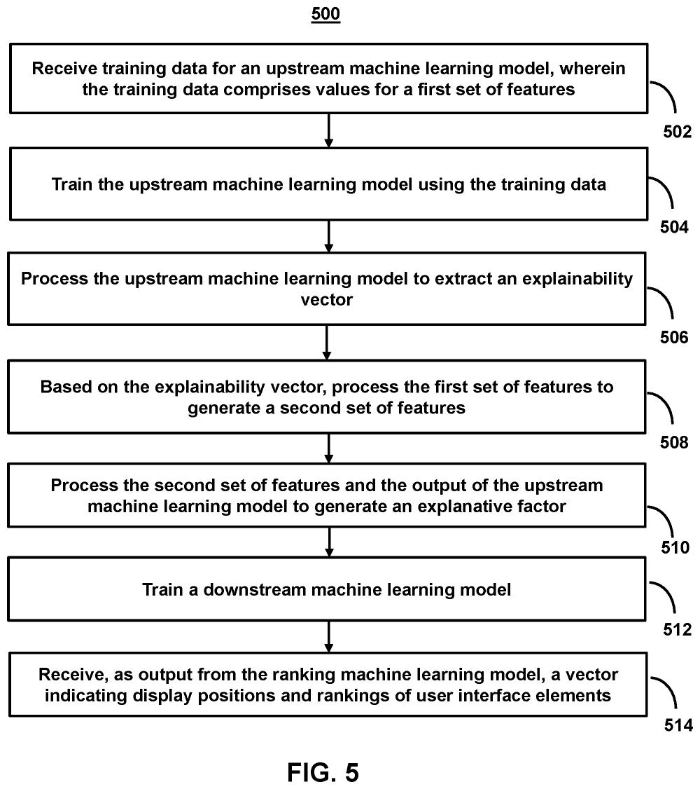

FIG. 5 shows a flowchart of the steps involved in ranking user interface elements using explainability vectors, in accordance with one or more embodiments. For example, the system may use process 500 (e.g., as implemented on one or more system components described above) in order to collect and process data about users, train resource consumption models, extract explainability vectors, and select and recombine features.

At step 502, process 500 (e.g., using one or more components described above) receives training data for an upstream machine learning model, wherein the training data comprises values for a first set of features. To do so, the system may retrieve one or more user profiles from User Profile Database(s) 132 and combine corresponding resource consumption values with the user profiles to generate a dataset. The system may retrieve, for a first plurality of user systems, a first plurality of user profiles, wherein each user profile includes values for a first set of features. For example, the system may use one or more software components (e.g., application programming interfaces) to browse User Profile Database(s) 132 and retrieve a dataset each entry for which corresponds to a user. A user profile is described by values in the first set of features. The first set of features may include quantitative or categorical variables. For example, the first set of features may include length of credit history, revolving credit utilization, credit lines and types of credit for a dataset relating to the creditworthiness of individuals. In some embodiments, the system may process the dataset of user profiles or User Profile Database(s) 132 using a data cleansing process to generate a processed dataset. The data cleansing process may include removing outliers, standardizing data types, formatting and units of measurement, and removing duplicate data. By collecting high-quality user profile data, the system may fully inform models that determine resource consumption for user systems.

At step 504, process 500 (e.g., using one or more components described above) trains the upstream machine learning model using the training data. The dataset may then be divided into a training set and a cross-validating set. The system may train the first machine learning model (e.g., Resource Availability Model 112) using the training set and tune parameters using the cross-validating set. The first machine learning model receives as input values for the set of features within User Profile Database(s) 132 and generates as output a corresponding resource consumption value. In some embodiments, Resource Availability Model 112 may alternatively or additionally output assignments of resource availability to user profiles.

At step 506, process 500 (e.g., using one or more components described above) processes the upstream machine learning model to extract an explainability vector. For example, if the first machine learning model is defined by a set of parameters comprising a matrix of weights for a multivariate regression algorithm, the explainability vector may be extracted from the set of parameters using the Shapley Additive Explanation method. For example, if the first machine learning model is defined by a set of parameters comprising a matrix of weights for a supervised classifier algorithm, the explainability vector may be extracted from the set of parameters using the Local Interpretable Model-agnostic Explanations method. For example, if the first machine learning model is defined by a set of parameters comprising a vector of coefficients for a generalized additive model, the explainability vector may be extracted from the vector of coefficients in the generalized additive model. For example, if the first machine learning model is defined by a set of parameters comprising a matrix of weights for a convolutional neural network algorithm, the explainability vector may be extracted from the set of parameters using the Gradient Class Activation Mapping method. For example, if the first machine learning model is defined by a set of parameters comprising a hyperplane matrix for a support vector machine algorithm, the explainability vector may be extracted from the set of parameters using the counterfactual explanation method. The explainability vector thus extracted (e.g., Explainability Vector 134) has the same number of entries as features in the first set of features. Each entry in this explainability vector represents the impact that a particular feature has on the model output.

At step 508, process 500 (e.g., using one or more components described above) processes the first set of features to generate a second set of features based on the explainability vector. In some embodiments, the system may first adjust values in the explainability vector. For example, the system may receive a user request specifying that a subset of features be removed from consideration or that impact of the subset of features be reduced. The system may also calculate a threshold for removing features of the explainability vector and add features below the threshold to the subset of features. This threshold may remove features deemed unimportant and may be a particular value in the explainability vector (e.g., 0.25). In some embodiments, this threshold can be a predetermined set number; in some other embodiments the threshold may be selected from the explainability vector. The system may apply a mathematical transformation to the explainability vector such that values corresponding to the subset of features are adjusted. In some embodiments, the values may be set to 0 to remove the corresponding features from consideration. In some embodiments, a percentage may be subtracted the values to downplay their impact.

The system (e.g., Feature Extraction Subsystem 116) may process the explainability vector to rearrange the first set of features into a second set of features. For example, Feature Extraction Subsystem 116 may process the explainability vector using one or more filtering criteria to adjust the values corresponding to certain features. For example, the system may receive a user request specifying that a subset of features be removed from consideration or that impact of the subset of features be reduced. In one example embodiment, the system may receive user profiles representing applicants for credit cards. A feature in the set of features may be the race or ethnicity of the applicant. The user may wish to exclude such features from consideration. Therefore, a subset of features to be removed may include, e.g., race and gender. Feature Extraction Subsystem 116 may, in addition, calculate a threshold for removing features of the explainability vector. In some embodiments, the threshold may correspond to a pre-set real number, e.g., 0.45. In other embodiments, Feature Extraction Subsystem 116 may simply remove the bottom 10% of features ranked by values in the explainability vector. Using the threshold, Feature Extraction Subsystem 116 may add features to the subset of features to be removed. Feature Extraction Subsystem 116 may apply a mathematical transformation to the explainability vector such that values corresponding to the subset of features are adjusted. For example, the values in the explainability vector for the subset of features may be set to zero, or the values may be halved.

In addition to the removal and transformation of features described above, Feature Extraction Subsystem 116 may combine features with reference to Explainability Vector 134. For example, it may select features with low values in Explainability Vector 134 and map one or more such features into one combined feature. Feature Extraction Subsystem 116 may, for example, multiply the absolute values for three features to generate one new feature. Alternatively, Feature Extraction Subsystem 116 may determine whether all three feature values exceed thresholds for each and create a new feature which outputs 1 if all values are above their respect thresholds, and outputs 0 otherwise. In some embodiments, Feature Extraction Subsystem 116 may use the correlation matrix attached with Explainability Vector 134 to determine which features to combine. In some embodiments, the system may use a deep neural network to learn weights and combination rules for Feature Extraction Subsystem 116 using Explainability Vector 134 as an input.

In some embodiments, Feature Extraction Subsystem 116 may employ a variety of techniques to rearrange or recombine the first set of features into the second set of features. For example, Feature Extraction Subsystem 116 may normalize Explainability Vector 134 into a standard-deviation space to produce a processed vector. Then, with reference to the correlation matrix attached to Explainability Vector 134, Feature Extraction Subsystem 116 may generate a covariance matrix based on the processed vector. The covariance matrix captures how the effects on the output of the model of one or more features correlate. Using the covariance matrix, Feature Extraction Subsystem 116 may compute a set of eigenvectors and eigenvalues for the covariance matrix (e.g., through the Singular Value Decomposition method). Each eigenvector corresponds to an eigenvalue and represents a feature in the first set of features. The relative proportions of the eigenvalues are directly correlated with the magnitude of a factor's explanative weight in Resource Availability Model 112. By normalizing the eigenvalues of all features in the first set of features, the system may determine what percentage of the explanative power of the model may be captured by each feature. Feature Extraction Subsystem 116 may then select a measure of coverage (e.g., a threshold percentage of the explanative power of the model). Using the measure of coverage, Feature Extraction Subsystem 116 may select a subset of eigenvectors from the set of eigenvectors. For example, if the measure of coverage is 55%, and three eigenvectors' eigenvalues add up to 56% when normalized, Feature Extraction Subsystem 116 may select the three eigenvectors. Feature Extraction Subsystem 116 may then determine the second set of features to correspond to the subset of eigenvectors.

At step 510, process 500 (e.g., using one or more components described above) processes the second set of features and the output of the upstream machine learning model to generate an explanative factor. For example, the explanative factor may be a matrix including values for the second set of features and for the first set of outputs. In training the downstream model, the system may partition the explanative factor into a training set and a cross-validating set. Using the training set, the system may train Feature Ranking Model 118 using, for example, the gradient descent technique. The system may then cross-validate the trained model using the cross-validating set and further fine-tune the parameters of the model. The explanative factor provides salient background information to a downstream model derived from an upstream model. For example, a model may be trained to rank and order elements for a user interface displaying factors related to assignments of resource availability. The ranking model may benefit from customizing the order of factors on the user interface based on the circumstances of the user system subject to the assignment of resource availability. For example, the ranking model, when generating an output indicating user interface order and display positions for a user system denied an amount of resources, may benefit from consideration of the factors that caused the user system to be denied (e.g., inefficiency in running a type of task related to the resource in question). Therefore, the ranking model may improve the accuracy of its outputs via taking as input an explanative factor including the features in a model for generating resource availability scores. The explanative factor may illustrate the nature and extent of the impact on the output of the predictive model from a feature.

At step 512, process 500 (e.g., using one or more components described above) trains a downstream machine learning model using the explanative factor and a third set of features as input. In some embodiments, the downstream model (e.g., Feature Ranking Model 118) may rank and order the first set of features used by the upstream model (e.g., Resource Availability Model 112) and may cause user interface elements corresponding to one or more features in the first set of features to displayed in a particular order or arrangement. To do so, Feature Ranking Model 118 may use a third set of features, which may be independent and different from the first set and the second set of features, to predict the display orders and positions of user interface elements on a user interface, which may correspond to expected perceptions of importance by the user and/or the probabilities that one or more of resources corresponding to the user interface elements will be accessed by the user. The third set of features may include, for example, the historical click-through rates for one or more user interface elements, among other features. The third set of features is not informed by the output of the upstream model (e.g., Resource Availability Model 112) and therefore do not overlap with the first or second sets of features. For example, a model may be trained to rank and order features solely using the third set of features. However, the system may instead train Feature Ranking Model 118 using the third set of features as well as the explanative factor like generated above. For example, Feature Ranking Model 118 may take input vectors in the same format as the explanative factor, which includes the second set of features and the output of Resource Availability Model 112. Feature Ranking Model 118 may output a vector symbolizing the rankings of user interface elements.

In another example, an upstream machine learning model (e.g., Resource Availability Model 112) may be trained on a corpus of raw text data to be a bidirectional encoder representation transformer model. The upstream model may take a first set of features an input and output a set of text representation tokens, each of which is a vector of real values corresponding to a word or a collection of words. The text representation tokens may be used as pre-processing for a downstream natural language processing model. The system may generate an explainability vector using the upstream model and use the explainability vector to process the first set of features into a second set of features. The system may then use the second set of features and the set of text representation tokens to generate an explanative factor. The system may train the downstream model using the explanative factor and a third set of features. The third set of features may relate only to the task of the downstream model. For example, the downstream model corresponding to a bidirectional encoder representation transformer upstream model may be a text sentiment analysis model. In addition to the explanative factor, the downstream model may use input text data and metadata associated with the text such as its source and its traffic data as training inputs. The downstream model may be trained to output sentiment classifications for the input text data contained in the third set of features.

At step 514, process 500 (e.g., using one or more components described above) receives, as output from the ranking machine learning model, a vector indicating display positions and rankings of user interface elements. In some embodiments, the system may use a template of display positions, which dictate the display positions, sizes and orientations for user interface elements based on their rank of importance. Using the template, the system may generate a user interface display arrangement including the user interface elements listed by the output of the ranking machine learning model.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

A1. A method for using explainability vectors to generate contextual data for training downstream models, the method comprising: receiving training data for an upstream machine learning model, wherein the training data comprises values for a first set of features; training the upstream machine learning model based on the training data, wherein the upstream machine learning model is a bidirectional encoder representation transformer model which outputs text representations, and wherein the text representations generated by the upstream machine learning model are input to a downstream machine learning model; using the upstream machine learning model, generating a first set of outputs based on the training data; processing the upstream machine learning model to extract an explainability vector, wherein each entry in the explainability vector corresponds to a feature in the first set of features and is indicative of a correlation between the feature and output of the upstream machine learning model; based on the explainability vector, processing the first set of features to generate a second set of features such that each feature in the second set of features has a correlation with the output of the upstream machine learning model that is above a correlation threshold; processing the second set of features and the first set of outputs to generate an explanative factor, wherein the explanative factor includes a set of features specifying real values which correspond to correlations between the second set of features and the first set of outputs; selecting a third set of features for use by a downstream machine learning model, wherein the third set of features represents input text data; based on the third set of features and the explanative factor, generating a fourth set of features; training the downstream machine learning model to output sentiment classifications, wherein the downstream machine learning model uses the fourth set of features as input; and using the downstream machine learning model, generating the sentiment classifications for input text data represented by the third set of features.

A2. A method for using explainability vectors to generate contextual data for training downstream models, the method comprising: receiving training data for an upstream machine learning model, wherein the training data comprises values for a first set of features; training the upstream machine learning model using the training data; in response to training the upstream machine learning model, processing the upstream machine learning model to extract an explainability vector, wherein each entry in the explainability vector corresponds to a feature in the first set of features and is indicative of a correlation between the feature and output of the upstream machine learning model; based on the explainability vector, processing the first set of features to generate a second set of features; processing the second set of features and the output of the upstream machine learning model to generate an explanative factor, wherein the explanative factor includes a set of features specifying real values which correspond to correlations between the second set of features and outputs of the upstream machine learning model; and training a downstream machine learning model, wherein the downstream machine learning model uses a third set of features and the explanative factor as input.

A3. The method of any one of the preceding embodiments, wherein processing the first set of features to generate the second set of features comprises: normalizing the explainability vector into a standard-deviation space to produce a processed vector; generating a covariance matrix based on the processed vector; computing a set of eigenvectors for the covariance matrix; selecting a measure of coverage and selecting a subset of eigenvectors from the set of eigenvectors based on the measure of coverage; and determining the second set of features corresponding to the subset of eigenvectors.

A4. The method of any one of the preceding embodiments, wherein processing the first set of features to generate the second set of features comprises: generating a correlation matrix based on the explainability vector; computing a set of eigenvectors for the correlation matrix; determining a threshold value using a distribution of the set of eigenvectors; and using a maximum-likelihood estimator model to extract the second set of features from the correlation matrix, wherein the maximum-likelihood estimator model takes the threshold value as an input.

A5. The method of any one of the preceding embodiments, wherein processing the second set of features and the output of the upstream machine learning model to generate the explanative factor comprises: generating an encoding map which translates the first set of features to the second set of features; using the output of the upstream machine learning model and the explainability vector, generating an embedding vector; and based on the encoding map and the embedding vector, generating the explanative factor.

A6. The method of any one of the preceding embodiments, wherein processing the first set of features to generate the second set of features comprises applying feature engineering using a multi-relational decision tree learning algorithm on the first set of features.

A7. The method of any one of the preceding embodiments, wherein: the upstream machine learning model is defined by a set of parameters comprising a matrix of weights for a multivariate regression algorithm; and the explainability vector is extracted from the set of parameters using a Shapley Additive Explanation method.

A8. The method of any one of the preceding embodiments, wherein: the upstream machine learning model is defined by a set of parameters comprising a matrix of weights for a supervised classifier algorithm; and the explainability vector is extracted from the set of parameters using a Local Interpretable Model-agnostic Explanations method.

A9. The method of any one of the preceding embodiments, wherein: the upstream machine learning model is defined by a set of parameters comprising a vector of coefficients for a generalized additive model; and the explainability vector is extracted from the vector of coefficients in the generalized additive model.

A10. The method of any one of the preceding embodiments, wherein: the upstream machine learning model is defined by a set of parameters comprising a matrix of weights for a convolutional neural network algorithm; and the explainability vector is extracted from the set of parameters using a Gradient Class Activation Mapping method.

A11. The method of any one of the preceding embodiments, wherein: the upstream machine learning model is defined by a set of parameters comprising a hyperplane matrix for a support vector machine algorithm; and the explainability vector is extracted from the set of parameters using a counterfactual explanation method.

A12. Anon-transitory, computer-readable medium storing instructions that, when executed by a data processing apparatus, cause the data processing apparatus to perform operations comprising those of any of embodiments A1-A11.

A13. A system comprising one or more processors; and memory-storing instructions that, when executed by the processors, cause the processors to effectuate operations comprising those of any of embodiments A1-A11.

A14. A system comprising means for performing any of embodiments A1-A11.

B1. A method for using explainability vectors to rank user interface elements, the method comprising: receiving training data for a predictive machine learning model that outputs resource availability scores, wherein the training data comprises values for a first set of features, wherein the first set of features comprises variables that influence resource availability; training the predictive machine learning model based on the training data; processing the predictive machine learning model to extract an explainability vector, wherein each entry in the explainability vector corresponds to a feature in the first set of features and is indicative of a correlation between the feature and output of the predictive machine learning model; based on the explainability vector, processing the first set of features to generate a second set of features such that each feature in the second set of features has a correlation with the output of the predictive machine learning model that is above a correlation threshold; processing the second set of features and the output of the predictive machine learning model to generate an explanative factor; determining to train a ranking machine learning model which uses a third set of features as input, wherein the third set of features contains variables affecting resource availability; training the ranking machine learning model, wherein the ranking machine learning model takes the third set of features and the explanative factor as input; and receiving, as output from the ranking machine learning model, a vector indicating display positions and rankings of one or more user interface elements for a software application.

B2. A method for using explainability vectors to rank user interface elements, the method comprising: receiving training data for a predictive machine learning model that outputs resource availability scores, wherein the training data comprises values for a first set of features; training the predictive machine learning model using the training data; in response to training the predictive machine learning model, processing the predictive machine learning model to extract an explainability vector, wherein each entry in the explainability vector corresponds to a feature in the first set of features and is indicative of a correlation between the feature and an output of the predictive machine learning model; based on the explainability vector, processing the first set of features to generate a second set of features; processing the second set of features and the output of the predictive machine learning model to generate an explanative factor; training a ranking machine learning model, wherein the ranking machine learning model takes a third set of features and the explanative factor as input; and receiving, as output from the ranking machine learning model, a vector indicating display positions and rankings of one or more user interface elements.

B3. The method of any one of the preceding embodiments, wherein processing the first set of features to generate the second set of features comprises: normalizing the explainability vector into a standard-deviation space to produce a processed vector; generating a covariance matrix based on the processed vector; computing a set of eigenvectors for the covariance matrix; selecting a measure of coverage and selecting a subset of eigenvectors from the set of eigenvectors based on the measure of coverage; and determining the second set of features corresponding to the subset of eigenvectors.

B4. The method of any one of the preceding embodiments, wherein processing the first set of features to generate the second set of features comprises: generating a correlation matrix based on the explainability vector; computing a set of eigenvectors for the correlation matrix; determining a threshold value using a distribution of the set of eigenvectors; and using a maximum-likelihood estimator model to extract the second set of features from the correlation matrix, wherein the maximum-likelihood estimator model takes the threshold value as an input.

B5. The method of any one of the preceding embodiments, wherein processing the second set of features and the output of the predictive machine learning model to generate an explanative factor comprises: generating an encoding map which translates the first set of features to the second set of features; using the output of the predictive machine learning model and the explainability vector, generating an embedding vector; and based on the encoding map and the embedding vector, generating the explanative factor.

B6. The method of any one of the preceding embodiments, further comprising: using the vector indicating rankings of one or more user interface elements, determining a display order of the one or more user interface elements; and based on the display order of the one or more user interface elements, causing to be displayed on a user interface on a user device the one or more user interface elements.

B7. The method of any one of the preceding embodiments, wherein: the predictive machine learning model is defined by a set of parameters comprising a matrix of weights for a multivariate regression algorithm; and the explainability vector is extracted from the set of parameters using a Shapley Additive Explanation method.

B8. The method of any one of the preceding embodiments, wherein: the predictive machine learning model is defined by a set of parameters comprising a matrix of weights for a supervised classifier algorithm; and the explainability vector is extracted from the set of parameters using a Local Interpretable Model-agnostic Explanations method.

B9. The method of any one of the preceding embodiments, wherein: the predictive machine learning model is defined by a set of parameters comprising a vector of coefficients for a generalized additive model; and the explainability vector is extracted from the vector of coefficients in the generalized additive model.

B10. The method of any one of the preceding embodiments, wherein: the predictive machine learning model is defined by a set of parameters comprising a matrix of weights for a convolutional neural network algorithm; and the explainability vector is extracted from the set of parameters using a Gradient Class Activation Mapping method.

B11. The method of any one of the preceding embodiments, wherein: the predictive machine learning model is defined by a set of parameters comprising a hyperplane matrix for a support vector machine algorithm; and the explainability vector is extracted from the set of parameters using a counterfactual explanation method.

B12. A tangible, non-transitory, machine-readable medium storing instructions that, when executed by a data processing apparatus, cause the data processing apparatus to perform operations comprising those of any of embodiments B1-B11.

B13. A system comprising one or more processors; and memory-storing instructions that, when executed by the processors, cause the processors to effectuate operations comprising those of any of embodiments B1-B11.

B14. A system comprising means for performing any of embodiments B1-B11.

What is claimed is:

1. A system for using explainability vectors to rank user interface elements, the system comprising:
receiving training data for a predictive machine learning model that outputs resource availability scores, wherein the training data comprises values for a first set of features, wherein the first set of features comprises variables that influence resource availability;
training the predictive machine learning model based on the training data;
processing the predictive machine learning model to extract an explainability vector, wherein each entry in the explainability vector corresponds to a feature in the first set of features and is indicative of a correlation between the feature and output of the predictive machine learning model;
based on the explainability vector, processing the first set of features to generate a second set of features such that each feature in the second set of features has a correlation with the output of the predictive machine learning model that is above a correlation threshold;
processing the second set of features and the output of the predictive machine learning model to generate an explanative factor;
determining to train a ranking machine learning model which uses a third set of features as input, wherein the third set of features contains variables affecting resource availability;
training the ranking machine learning model, wherein the ranking machine learning model takes the third set of features and the explanative factor as input; and
receiving, as output from the ranking machine learning model, a vector indicating display positions and rankings of one or more user interface elements for a software application.

2. A method for using explainability vectors to rank user interface elements, the method comprising:
receiving training data for a predictive machine learning model that outputs resource availability scores, wherein the training data comprises values for a first set of features;
training the predictive machine learning model using the training data;
in response to training the predictive machine learning model, processing the predictive machine learning model to extract an explainability vector, wherein each entry in the explainability vector corresponds to a feature in the first set of features and is indicative of a correlation between the feature and an output of the predictive machine learning model;
based on the explainability vector, processing the first set of features to generate a second set of features;
processing the second set of features and the output of the predictive machine learning model to generate an explanative factor;
training a ranking machine learning model, wherein the ranking machine learning model takes a third set of features and the explanative factor as input; and
receiving, as output from the ranking machine learning model, a vector indicating display positions and rankings of one or more user interface elements.

3. The method of claim 2, wherein processing the first set of features to generate the second set of features comprises:
normalizing the explainability vector into a standard-deviation space to produce a processed vector;
generating a covariance matrix based on the processed vector;
computing a set of eigenvectors for the covariance matrix;
selecting a measure of coverage and selecting a subset of eigenvectors from the set of eigenvectors based on the measure of coverage; and
determining the second set of features corresponding to the subset of eigenvectors.

4. The method of claim 2, wherein processing the first set of features to generate the second set of features comprises:
generating a correlation matrix based on the explainability vector;
computing a set of eigenvectors for the correlation matrix;
determining a threshold value using a distribution of the set of eigenvectors; and
using a maximum-likelihood estimator model to extract the second set of features from the correlation matrix, wherein the maximum-likelihood estimator model takes the threshold value as an input.

5. The method of claim 2, wherein processing the second set of features and the output of the predictive machine learning model to generate an explanative factor comprises:
generating an encoding map which translates the first set of features to the second set of features;
using the output of the predictive machine learning model and the explainability vector, generating an embedding vector; and
based on the encoding map and the embedding vector, generating the explanative factor.

6. The method of claim 2, further comprising:
using the vector indicating rankings of one or more user interface elements, determining a display order of the one or more user interface elements; and
based on the display order of the one or more user interface elements, causing to be displayed on a user interface on a user device the one or more user interface elements.

7. The method of claim 2, wherein:
the predictive machine learning model is defined by a set of parameters comprising a matrix of weights for a multivariate regression algorithm; and
the explainability vector is extracted from the set of parameters using a Shapley Additive Explanation method.

8. The method of claim 2, wherein:
the predictive machine learning model is defined by a set of parameters comprising a matrix of weights for a supervised classifier algorithm; and
the explainability vector is extracted from the set of parameters using a Local Interpretable Model-agnostic Explanations method.

9. The method of claim 2, wherein:
the predictive machine learning model is defined by a set of parameters comprising a vector of coefficients for a generalized additive model; and
the explainability vector is extracted from the vector of coefficients in the generalized additive model.

10. The method of claim 2, wherein:
the predictive machine learning model is defined by a set of parameters comprising a matrix of weights for a convolutional neural network algorithm; and
the explainability vector is extracted from the set of parameters using a Gradient Class Activation Mapping method.

11. The method of claim 2, wherein:
the predictive machine learning model is defined by a set of parameters comprising a hyperplane matrix for a support vector machine algorithm; and
the explainability vector is extracted from the set of parameters using a counterfactual explanation method.

12. A non-transitory computer-readable medium comprising instructions that, when executed by one or more processors, cause operations comprising:
receiving training data for a predictive machine learning model that outputs resource availability scores, wherein the training data comprises values for a first set of features;
training the predictive machine learning model using the training data;
in response to training the predictive machine learning model, processing the predictive machine learning model to extract an explainability vector, wherein each entry in the explainability vector corresponds to a feature in the first set of features and is indicative of a correlation between the feature and an output of the predictive machine learning model;
based on the explainability vector, processing the first set of features to generate a second set of features;
processing the second set of features and the output of the predictive machine learning model to generate an explanative factor;
training a ranking machine learning model, wherein the ranking machine learning model takes a third set of features and the explanative factor as input; and
receiving, as output from the ranking machine learning model, a vector indicating display positions and rankings of one or more user interface elements.

13. The non-transitory computer-readable medium of claim 12, wherein processing the first set of features to generate the second set of features comprises:
normalizing the explainability vector into a standard-deviation space to produce a processed vector;
generating a covariance matrix based on the processed vector;
computing a set of eigenvectors for the covariance matrix;
selecting a measure of coverage and selecting a subset of eigenvectors from the set of eigenvectors based on the measure of coverage; and
determining the second set of features corresponding to the subset of eigenvectors.

14. The non-transitory computer-readable medium of claim 12, wherein processing the first set of features to generate the second set of features comprises:
generating a correlation matrix based on the explainability vector;
computing a set of eigenvectors for the correlation matrix;
determining a threshold value using a distribution of the set of eigenvectors; and
using a maximum-likelihood estimator model to extract the second set of features from the correlation matrix, wherein the maximum-likelihood estimator model takes the threshold value as an input.

15. The non-transitory computer-readable medium of claim 12, wherein processing the second set of features and the output of the predictive machine learning model to generate an explanative factor comprises:
generating an encoding map which translates the first set of features to the second set of features;
using the output of the predictive machine learning model and the explainability vector, generating an embedding vector; and
based on the encoding map and the embedding vector, generating the explanative factor.

16. The non-transitory computer-readable medium of claim 12, further comprising:
using the vector indicating rankings of one or more user interface elements, determining a display order of the one or more user interface elements; and
based on the display order of the one or more user interface elements, causing to be displayed on a user interface on a user device the one or more user interface elements.

17. The non-transitory computer-readable medium of claim 12, wherein:
the predictive machine learning model is defined by a set of parameters comprising a matrix of weights for a multivariate regression algorithm; and
the explainability vector is extracted from the set of parameters using a Shapley Additive Explanation method.

18. The non-transitory computer-readable medium of claim 12, wherein:
the predictive machine learning model is defined by a set of parameters comprising a matrix of weights for a supervised classifier algorithm; and
the explainability vector is extracted from the set of parameters using a Local Interpretable Model-agnostic Explanations method.

19. The non-transitory computer-readable medium of claim 12, wherein:
the predictive machine learning model is defined by a set of parameters comprising a vector of coefficients for a generalized additive model; and
the explainability vector is extracted from the vector of coefficients in the generalized additive model.

20. The non-transitory computer-readable medium of claim 12, wherein:
the predictive machine learning model is defined by a set of parameters comprising a matrix of weights for a convolutional neural network algorithm; and
the explainability vector is extracted from the set of parameters using a Gradient Class Activation Mapping method.
